(19) United States
(12) Patent Application Publication
(10) Pub. No.: US 2008/0233392 A1
(43) Pub. Date: Sep. 25, 2008

(54) ADHESIVE SHEET

(75) Inventors: Keiko Tanaka, Gunma (JP); Jun Maeda, Saitama (JP); Masaharu Ito, Saitama (JP)

Correspondence Address: DITTHAVONG MORI & STEINER, P.C., 918 Prince St., Alexandria, VA, 22314, US

(73) Assignee: LINTEC Corporation, Tokyo (JP)

(21) Appl. No.: 12/051,731

(22) Filed: Mar. 19, 2008

(30) Foreign Application Priority Data
Mar. 20, 2007 (JP) 2007-072510

(51) Int. Cl. B32B 7/12

(52) U.S. Cl. 428/345

(57) ABSTRACT

An adhesive sheet includes a substrate and an energy-ray curable adhesive layer formed on the substrate. The energy-ray curable adhesive layer includes an energy-ray curable acrylic copolymer and an energy-ray curable urethane acrylate. The energy-ray curable acrylic copolymer is formed by copolymerizing dialkyl(meth)acrylamide and includes a side chain with an unsaturated group. The energy-ray curable urethane acrylate includes an isocyanate block and a (meth)acryloyl group. The isocyanate block includes at least one of an isophorone diisocyanate, a trimethyl-hexamethyene diisocyanate, and a tetramethyl-xylene diisocyanate.

### BACKGROUND OF THE INVENTION

1. Field of the Invention

The present invention relates to an adhesive sheet, especially to an adhesive sheet which is suitable for protecting a semiconductor circuit when a semiconductor wafer, upon which high density circuit patterns are formed, is processed.

2. Description of the Related Art

A backside surface of a semiconductor wafer is ground after circuits are formed on a front side surface thereof, so that the thickness of the semiconductor wafer is adjusted. During the grinding process, an adhesive sheet as a protective sheet is adhered to the front side surface to protect the circuits formed thereon. Such a protective sheet is required not only to prevent damage to the circuits or the wafer body, but also to prevent contamination to the circuit caused by residual adhesive matter following removal, to prevent the penetration of water used in the grinding onto the circuit surface, and to contribute to sufficient accuracy of the wafer thickness resulting from the grinding process. As such a protective sheet, an adhesive sheet including an ultraviolet-ray-curable adhesive, is known (Japanese unexamined Patent Publication No. S60-189938).

In regular manufacturing processes, a semiconductor wafer is diced in a dicing process after a grinding process. Recently, treating a ground wafer has become increasingly difficult in semiconductor manufacturing processes, because the diameter of the wafer has been increasing while the thickness of the wafer has been decreasing, thus the semiconductor wafer is becoming increasingly breakable. Therefore, the so-called DBG process (that is, dicing before grinding process), where the wafer is partially cut (i.e. a half-cut process) before the grinding process chips the wafer, is promising. In the DBG process, a protective sheet is adhered to the circuit surface of a wafer after undergoing the half cut process (Japanese unexamined Patent Publication No. H05-335411).

In a conventional process, a protective sheet firmly adhered to the circuit surface of a wafer need only prevent penetration of water at the edge of the wafer. On the contrary, in the DBG process, sufficient adhesion to the surface of each chip of a wafer is required to prevent the penetration of the washing water, because the wafer has already been chipped during the grinding process. When the adhesion of a protective sheet is increased to strengthen adhesion to the circuit surface of the wafer, there is a trend of increasing the problem of adhesive residue remaining on the circuit surface after the protective sheet has been stripped away. To solve this problem, it is known that an adhesive sheet including an energy-ray curable adhesive, such as an ultraviolet ray curable adhesive, may be used as a protective sheet, for example, Japanese unexamined Patent Publication No. 200-68237.

Because the shapes of semiconductor parts have been changing with respect to the past, relatively uneven elements such as an electrode tend to collect at the periphery of a semiconductor chip, that is, uneven elements tend to be concentrated in a narrow area. Therefore, effectively adhering a protective sheet to the edge of a semiconductor chip is becoming more difficult, so that the protective sheet used in the DBG process may not seal the circuit surface effectively due to poor adhesion to the circuits (followability to bond to the uneven circuit surface). As a result, a problem where water for grinding penetrates the circuit surface has arisen. Further, if compatibilities of contents of the energy-ray curable adhesive between each other are poor, the characteristics of the energy-ray curable adhesive layer are not suitable, so that a problem where the adhesive residue is increased will arise.

### SUMMARY OF THE INVENTION

Therefore, the objective of the present invention is to realize an adhesive sheet, that has sufficient adhesion strength and followability to bond to the uneven circuit surface of a wafer and so on, so that it can prevent the penetration of water such as water for grinding used during grinding processes onto the circuit surface of a wafer, and prevent residual adhesive matter.

An adhesive sheet, according to the present invention, includes a substrate and an energy-ray curable adhesive layer formed on the substrate. The energy-ray curable adhesive layer includes an energy-ray curable acrylic copolymer and an energy-ray curable urethane acrylate. The energy-ray curable acrylic copolymer is formed by copolymerizing dialkyl (meth) acrylamide and includes a side chain with an unsaturated group. The energy-ray curable urethane acrylate includes an isocyanate block and a (meth)acryloyl group. The isocyanate block includes at least one of an isophorone diisocyanate, a trimethyl-hexamethyene diisocyanate, and a tetramethyl-xylene diisocyanate.

### DESCRIPTION OF THE PREFERRED EMBODIMENT

Hereinafter, the embodiment of the present invention is explained. An adhesive sheet includes a substrate, and an energy-ray curable adhesive layer formed on the substrate. When the adhesive sheet is used, the energy-ray curable adhesive layer is adhered to a circuit surface of a semiconductor wafer. When the semiconductor wafer is processed by using the DBG process explained below, the backside surface of the semiconductor wafer is ground with the adhesive sheet adhered to the circuit surface thereof. At the time, the adhesive sheet prevents the penetration of the grinding water onto the circuit surface, and prevents the individual chips from coming into contact with each other, thus protecting the semiconductor wafer.

Next, the energy-ray curable adhesive layer is explained. The energy-ray curable adhesive layer includes primarily an energy-ray curable acrylic copolymer and an energy-ray curable urethane acrylate oligomer (urethane acrylate). The energy-ray curable acrylic copolymer includes a reactant of an acrylic copolymer and an unsaturated compound having an unsaturated group, chemically bonded to each other. The energy-ray curable adhesive layer further includes components of a crosslinking agent and others, in addition to the energy-ray curable acrylic copolymer and urethane acrylate.

Each component of the energy-ray curable adhesive layer is explained below. The acrylic copolymer is a copolymer of a main monomer, a dialkyl(meth)acrylamide (N,N-dialkyl(meth)acrylamide), a functional monomer, and so on.

The main monomer provides the fundamental characteristics for the energy-ray curable adhesive layer to function as an adhesive layer. As a main monomer, for example, (meth)acrylic acid ester monomer, or a constitutional unit of the derivatives thereof is used. The (meth)acrylic acid ester monomers that have an alkyl group with carbon number 1 to 18, can be used. In these (meth)acrylic acid ester monomers, preferably, methyl acrylate, methyl methacrylate, ethyl acrylate, ethyl methacrylate, propyl acrylate, propyl methacrylate, butyl acrylate, butyl methacrylate, 2-ethyl hexyl acrylate, 2-ethyl hexyl methacrylate, are used. These main monomers are preferably included in 50 to 90 weight percent of all monomers to form the acrylic copolymer.

The acrylic copolymer includes a dialkyl(meth)acrylamide as a constitutional monomer. The compatibility of the energy-ray curable acrylic copolymer to a urethane acrylate which has high polarity, is improved by using the dialkyl(meth)acrylamide as a constitutional monomer. As the dialkyl(meth)acrylamide, a dimethyl(meth)acrylamide, a diethyl(meth)acrylamide, and others are used, especially preferably, a dimethyl(meth)acrylamide is used.

These dialkyl(meth)acrylamides are preferable because they include an amino group whose reactivity is restrained due to alkyl groups, effectively eliminating a negative impact on polymerization and other reactions. Further, the dimethylacrylamide which has the highest polarity among these dialkyl (meth) acrylamides is especially suitable for improving the compatibility of the energy-ray curable acrylic copolymer to the urethane acrylate with high polarity. Note that dialkyl (meth) acrylamides are preferably included in 1 to 30 weight percent of the acrylic copolymer as a constitutional monomer thereof.

The functional monomer is used to make the unsaturated compound bondable to the acrylic copolymer and to provide a functional group which is required, as explained below, for a reaction with a crosslinking agent. That is, a monomer which intramolecularly consists of a polymerizing double bond and a functional group such as a hydroxyl group, a carboxyl group, an amino group, a substituted amino group, or an epoxy group. Preferably, a compound with a hydroxyl group, a carboxyl group, or the like is used.

More specific examples of the functional monomer are; (meth)acrylates with a hydroxyl group, such as 2-hydroxyethyl acrylate, 2-hydroxyethyl methacrylate, 2-hydroxypropyl acrylate, and 2-hydroxypropyl methacrylate; compounds with a carboxyl group, such as an acrylic acid, a methacrylic acid, and an itaconic acid; (meth)acrylate with an amino group, such as N-(2-aminoethyl)acrylamide, and N-(2-aminoethyl)methacrylamide; (meth)acrylates with a substituted amino group, such as monomethyl aminoethyl acrylate and monomethyl aminoethyl methacrylate; (meth)acrylates with an epoxy group, such as a glycidyl acrylate, and a glycidyl methacrylate. These functional monomers are preferably included in 1 to 30 weight percent of all monomers to form the acrylic copolymer, as a constitutional monomer.

The acrylic copolymer is formed by a known method for copolymering the monomers explained above, that is, the main monomer, the dialkyl(meth)acrylamide, and the functional monomer. However, monomers other than these may be included in the acrylic copolymer. For example, a vinyl formate, a vinyl acetate, or a styrene may be copolymerized and included in the acrylic copolymer in the ratio of approximately or below 10 weight percent.

Next, the unsaturated compound is explained. The unsaturated compound is used to provide an energy-ray curing property to the energy-ray curable acrylic copolymer. That is, the energy-ray curable acrylic copolymer acquires its energy-ray curing property, due to the addition of the unsaturated compound that is polymerized by the radiation of ultraviolet ray or some other radiation. The energy-ray curable acrylic copolymer is formed by the reaction of the acrylic copolymer which contains functional groups and is formed as explained above, together with the unsaturated compound which has substituted groups reactive to the functional groups of the acrylic copolymer.

The substituted group of the unsaturated compound is selected according to the type of functional group of the acrylic copolymer, that is, according to the type of functional group of the monomers used for forming the acrylic copolymer. For example, when the functional group of the acrylic copolymer is a hydroxyl group or a carboxyl group, the substituted group preferably is an isocyanate group or an epoxy group; when the functional group is an amino group or a substituted amino group, the substituted group preferably is an isocyanate group; and when the functional group is an epoxy group, the substituted group preferably is a carboxyl group. Such a substituted group is provided in each molecule of the unsaturated compound.

The unsaturated compound includes approximately 1 to 5 double bonds for polymerization, preferably with one or two double bonds in one molecule. The examples of such unsaturated compounds are methacryloyl oxyethyl isocyanate, meta-isopropenyl-α,α-dimethylbenzyl isocyanate, methacryloyl isocyanate, allyl isocyanate, glycidyl (meth)acrylate, (meth)acrylic acid, or so on.

The unsaturated compound is reacted with the acrylic copolymer in the ratio of approximately 20 to 100 equivalents, preferably 40 to 90 equivalents, and ideally approximately 50 to 80 equivalents of the unsaturated compound to 100 equivalents of the functional group of the acrylic copolymer. The reaction of the acrylic copolymer and the unsaturated compound is carried out under conventional conditions, such as the condition where a catalyst in ethyl acetate that is used as a solvent, and stirred for 24 hours at room temperature under atmospheric pressure.

As a result, the functional groups in the side chains of the acrylic copolymer react with the substituted groups in the unsaturated compound, thus generating the energy-ray curable acrylic copolymer in which unsaturated groups have been introduced to the side chains of the acrylic copolymer therein. The reaction rate of the functional groups to the substituted groups in the reaction is more than 70 percent, and preferably more than 80 percent, and a portion of unreacted unsaturated compounds may remain in the energy-ray curable acrylic copolymer. The weight average molecular weight of the energy-ray curable acrylic copolymer formed by the reaction explained above is preferably more than 100,000, and ideally 200,000 to 2,000,000, with the glass transition temperature thereof preferably approximately in the range of −70 to 10 degrees Celsius.

The energy-ray curable urethane acrylate that is mixed with the energy-ray curable acrylic copolymer is explained below. The energy-ray curable urethane acrylate is a compound that includes a isocyanate block, a urethane bond, and a (meth)acryloyl group at the terminal thereof. Various compounds can be used as the urethane acrylate. For example, a compound that is obtained from reacting a urethane oligomer which has functional groups at the terminal thereof, with a compound which has a (meth) acryloyl group, can be used as the urethane acrylate. In this formulation, the urethane oligomer is generated in advance by reactions between polyisocyanate and polyols such as alkylene polyols or polyether compounds or the like, with hydroxyl groups at the terminals thereof. Another compound, which is formed by reactions of polyether compounds or polyester compounds, both having hydroxyl groups at the terminals thereof, with compounds having a (meth)aclyloyl group, and with a polyisocyanate, can be used as the urethane acrylate. Such urethane acrylates have energy-curing properties due to the action of the (meth)aclyloyl groups.

As the polyisocyanate mentioned above, an isophorone diisocyanate (IPDI), a trimethyl-hexamethlyene diisocyanate (TMDI), a tetramethyl-xylene diisocyanate (TMXDI), and other diisocyanates can be used. These polyisocyanates are included in the energy-ray curable urethane acrylate, preferably in 3 to 50 weight percent, more preferably, in 20 to 40 weight percent. In these polyisocyanates, using the isophorone diisocyanate (IPDI) is especially preferable.

As an acrylate to form the (meth)aclyloyl group, a 2-hydroxyethyl acrylate (2HEA), a 2-hydroxypropyl acrylate (2HPA), a 4-hydroxybutyl acrylate (4HBA), and others are used. These acrylates are included in the energy-ray curable urethane acrylate, preferably in 1 to 20 weight percent, and more preferably in 5 to 15 weight percent.

In the energy-ray curable urethane acrylate, a polyol block that is generated from, for example, polyalkylene glycol, may be included. As a polyol to form a polyol block, a polypropylene glycol (PPG, number average molecular weight of 700), a polyethylene glycol (PEG, number average molecular weight of 600), polytetramethylene glycol (PTMG, number average molecular weight of 850), a polycarbonate diol (PCDL, number average molecular weight of 800), and others can be used. The number average molecular weight of these polyols is preferably between 300 and 2,000. When these polyols are included in the energy-ray curable urethane acrylate, polyols are preferably included in 30 to 95 weight percent, more preferably in 50 to 70 weight percent.

The energy-ray curable urethane acrylate is mixed with 100 weight parts of energy-ray curable acrylic copolymer, preferably in the ratio of 1 to 200 weight parts of urethane acrylate, and more preferably 5 to 100 weight parts thereof, and ideally 10 to 50 weight parts thereof, with 100 weight parts of energy-ray curable acrylic copolymer. The number average molecular weight of the urethane acrylate molecule is preferably in the range of 300 to 30,000, in terms of the compatibility with the energy-ray curable acrylic copolymer and the processing properties of the energy-ray curable adhesive layer. More preferably, the number average molecular weight of the urethane acrylate is lower than or equal to 20,000, and for example, the urethane acrylate is an oligomer whose number average molecular weight is in the range of 1,000 to 15,000.

The energy-ray curable adhesive layer of the present invention may include a crosslinking agent. The selection of the crosslinking agent which can be bonded to the functional group derived from the functional monomer is explained below. For example, when the functional group is one which has an active hydrogen such as a hydroxyl group, a carboxyl group, or an amino group; organic polyisocyanate compounds, organic polyepoxy compounds, organic polyimine compounds, or metal chelate compounds can be selected as the crosslinking agent. Examples of the organic polyisocyanate compound are, for example, aromatic organic polyisocyanate compounds, aliphatic organic polyisocyanate compounds, alicyclic organic polyisocyanate compounds, and so on. More specific examples of the organic polyisocyanate compounds are, for example, 2,4-tolylene diisocyanate, 2,6-tolylene diisocyanate, 1,3-xylylene diisocyanate, 1,4-xylene diisocyanate, diphenylmethane 4,4-diisocyanate, diphenylmethane 2,4′-diisocyanate, 3-methyldiphenylmethane diisocyanate, hexamethyene diisocyanate, isophorone diisocyanate, dicyclohexylmethane 4,4′-diisocyanate, dicyclohexylmethane 2,4′-diisocyanate, lysine isocyanate, and so on. In addition, trimers of these polyisocyanate compounds, and a urethane prepolymer having terminal isocyanate functions generated by reactions of these polyisocyanate compounds and polyol compounds, and others are more examples of the organic polyisocyanate compounds.

Further, specific examples of the organic polyepoxy compounds are bisphenol A type epoxy compounds, bisphenol F type epoxy compounds, 1,3-bis(N,N-diglycidyl-aminomethyl)benzene, 1,3-bis(N,N-diglycidyl-aminomethyl)toluene, N,N,N′,N′-tetraglycidyl-4,4-diaminophenyl methane, and so on. Further, specific examples of the organic polyimine compounds are N,N′-diphenylmethane-4,4′-bis(1-aziridine carboxamide), trimethylolpropane-tri-β-aziridinylpropionate, tetramethylolmethane-tri-β-aziridinylpropionate, N,N′-toluene-2,4-bis(1-aziridine carboxamide), triethylenemelamine, and so on. Note that the quantity of the crosslinking agent is preferably in the range of approximately 0.01 to 20 weight parts, and ideally in the range of approximately 0.1 to 10 weight parts, to the 100 weight parts of the energy-ray curable acrylic copolymer.

When the ultraviolet ray is used for curing the energy-ray curable acrylic copolymer, a photopolymerization initiator is added to the energy-ray curable adhesive layer to shorten the polymerization time and reduce the dose of the ultraviolet ray. As the photopolymerization initiator, for example, benzophenone, acetophenone, benzoin, benzoin methyl ether, benzoin ethyl ether, benzoin isopropyl ether, benzoin isobutyl ether, benzoin benzoate, benzoin methyl benzoate, benzoin dimethyl ketal, 2,4-diethylthioxanthone, α-hydroxy cyclohexyl phenyl keton, benzyl diphenyl sulfide, tetramethyl thiuram monosulfide, azobisisobutyronitrile, benzil, dibenzil, diacetyl, β-chloro anthraquinone, or 2,4,6-trimethylbenzoyl diphenylphosphine oxide are used. Note that the amount of photopolymerization initiator is preferably 0.1 to 10 weight parts, and ideally approximately 0.5 to 5 weight parts, to 100 weight parts of the energy-ray curable acrylic copolymer.

In addition to these agents, additives such as an anti-aging agent, a stabilizer, a plasticizer, a coloring agent, and so on may be formulated in the energy-ray curable adhesive layer to meet various requirements, without any restriction on a ratio thereof not to depart from the purpose of the present invention.

The energy-ray curable adhesive layer of the above explained formulation is a mixture of different components which have relatively high molecular weights. Generally, a mixture of compounds having high molecular weights has low self-compatibility and the physical properties thereof tend to become unstable. Further, when the energy-ray curable adhesive layer, as a mixture, has low self-compatibility, residual adhesive material tends to be left on the adherend, even when the energy-ray curable adhesive layer is cured. On the other hand, in the energy-ray curable adhesive layer of the present invention, the urethane acrylate of the above explained formulation has sufficient compatibility with the energy-ray curable acrylic copolymer. Therefore, the energy-ray curable adhesive layer has a stable adhesion property. Note that the compatibility of the energy-ray curable adhesive layer can be evaluated by measuring the haze value, because a mixture having low compatibility is turbid and becomes hazy.

The value of the storage modulus G′ at 25 degrees Celsius of the energy-ray curable adhesive layer, is preferably less than or equal to 0.15 MPa, and ideally between 0.03 to 0.11 MPa, while the value of the loss tangent (tan δ=loss modulus/storage modulus) at 25 degrees Celsius is preferably greater than or equal to 0.4, and ideally in the range of 0.4 to 3, when the energy-ray curable adhesive layer is not cured by energy-ray. As explained, when the value of the storage modulus G′ is less than or equal to 0.15 MPa, and the value of the loss tangent 5 is greater than or equal to 0.4, the energy-ray curable adhesive layer has sufficient followability to bond to the uneven wafer and reliably prevents penetration of grinding water onto the circuit surface.

Note that the minimum value of the storage modulus G′ is not limited to 0.03 MPa and may be lower than that, as long as the energy-ray curable adhesive layer can be put to practical use. Similar to the storage modulus G′, the maximum value of the loss tangent δ is not limited to 3 and may be greater than that, as long as the energy-ray curable adhesive layer functions adequately.

The thickness of the energy-ray curable adhesive layer, which is determined according to the required surface protection property for a semiconductor wafer or other adherends, is preferably in the range of 10 to 200 μm, and ideally in the range 10 of 20 to 100 μm.

Next, the substrate is explained. The material for the substrate is not limited; for example, a polyethylene film, a polypropylene film, a polybutylene film, a polybutadiene film, a polymethylpentene film, a polyvinylchloride film, a polyvinylchloride copolymer film, a polyethylene terephthalate film, a polybutylene terephthalate film, a polyurethane film, an ethylene vinylacetate film, an ionomer resin film, an ethylene (meth)acrylic acid copolymer film, a polystyrene film, a polycarbonate film, a fluorocarbon resin film, and other films can be used. Further, crosslinked films or laminated films of these materials can also be used.

Note that the substrate needs to have a transmittance for the wavelength range of the energy-ray in use. Therefore, for example, when an ultraviolet ray is used as an energy-ray, the substrate needs to have a light transmittance. When an electron-beam is used, the substrate does not need to have a light transmittance so that colored substrate may be used. The thickness of the substrate, which is adjusted according to the required properties of the adhesive sheet, is preferably in the range of 20 to 300 μm, and ideally in the range of 50 to 150 μm.

A release film for protecting the energy-ray curable adhesive layer may be laminated onto the adhesive sheet of the present invention. A film of polyethylene terephthalate, polyethylene naphtahalate, polypropyrene, polyethyrene, or so on, may be used as the release film when the surface on one side of which is treated with a release agent of silicone resin or the like. However, the release film is not limited to those described above.

Next, the production method for the adhesive sheet of the present invention is explained. Table 1 is a formulation table of energy-ray curable urethane acrylates in working examples 1 to 6 and comparative examples 1 to 8 of energy-ray curable adhesives. In Table 1, the number average molecular weight of each of the energy-ray curable urethane acrylates, and each ratio (weight ratio) of polyisocyanates, polyols, and acrylates are represented.

TABLE 1

| | | ENERGY-RAY CURABLE URETHANE ACRYLATE | | | | | | |
|---|---|---|---|---|---|---|---|---|
| | ENERGY-RAY | | NUMBER | | | | | |
| | CURABLE | | AVERAGE | | | | | |
| | ACRYLIC | | MOLECULAR | POLYISOCYANATE | | | | |
| | COPOLYMER | AMOUNT | WEIGHT | IPDI | H12MDI | H6XDI | TMDI | TMXDI |
| WORKING | 100 | 20 | 5000 | 28 | — | — | — | — |
| EXAMPLE 1 | | | | | | | | |
| WORKING | 100 | 20 | 6000 | 29 | — | — | — | — |
| EXAMPLE 2 | | | | | | | | |
| WORKING | 100 | 20 | 14000 | 28 | — | — | — | — |
| EXAMPLE 3 | | | | | | | | |
| WORKING | 100 | 20 | 7000 | — | — | — | 27 | — |
| EXAMPLE 4 | | | | | | | | |
| WORKING | 100 | 20 | 8000 | — | — | — | — | 30 |
| EXAMPLE 5 | | | | | | | | |
| WORKING | 100 | 20 | 5000 | 34 | — | — | — | — |
| EXAMPLE 6 | | | | | | | | |
| COMPARATIVE | 100 | 20 | 9000 | — | — | 23 | — | — |
| EXAMPLE 1 | | | | | | | | |
| COMPARATIVE | 100 | 20 | 30000 | — | — | 24 | — | — |
| EXAMPLE 2 | | | | | | | | |
| COMPARATIVE | 100 | 20 | 14000 | — | 38 | — | — | — |
| EXAMPLE 3 | | | | | | | | |
| COMPARATIVE | 100 | 20 | 5000 | — | — | 31 | — | — |
| EXAMPLE 4 | | | | | | | | |
| COMPARATIVE | 100 | 0 | — | — | — | — | — | — |
| EXAMPLE 5 | | | | | | | | |
| COMPARATIVE | 100 | 0 | — | — | — | — | — | — |
| EXAMPLE 6 | | | | | | | | |
| COMPARATIVE | 100 | 20 | 9600 | — | — | 30 | — | — |
| EXAMPLE 7 | | | | | | | | |
| COMPARATIVE | 100 | 20 | 780 | — | — | 73 | — | — |
| EXAMPLE 8 | | | | | | | | |

| | | | |
|---|---|---|---|
| WEIGHT | WEIGHT | — | WEIGHT PART RATIO |
| PART | PART | | (SOLID CONTENT RATIO) |

| | ENERGY-RAY CURABLE | | | | | |
|---|---|---|---|---|---|---|
| | URETHANE ACRYLATE | | | | | |
| | POLYOL | | | ACRYLATE | | |
| | PPG | PCDL | PTMG | 2HEA | 2HPA | 4HBA |
| WORKING | 60 | — | — | — | 12 | — |
| EXAMPLE 1 | | | | | | |
| WORKING | 61 | — | — | 10 | — | — |
| EXAMPLE 2 | | | | | | |
| WORKING | 60 | — | — | — | — | 12 |
| EXAMPLE 3 | | | | | | |
| WORKING | 61 | — | — | — | 12 | — |
| EXAMPLE 4 | | | | | | |
| WORKING | 58 | — | — | — | 12 | — |
| EXAMPLE 5 | | | | | | |
| WORKING | — | 51 | — | 15 | — | — |
| EXAMPLE 6 | | | | | | |
| COMPARATIVE | — | — | 67 | 10 | — | — |
| EXAMPLE 1 | | | | | | |
| COMPARATIVE | 67 | — | — | 9 | — | — |
| EXAMPLE 2 | | | | | | |
| COMPARATIVE | — | 48 | — | — | 14 | — |
| EXAMPLE 3 | | | | | | |
| COMPARATIVE | — | 54 | — | — | 15 | — |
| EXAMPLE 4 | | | | | | |
| COMPARATIVE | — | — | — | — | — | — |
| EXAMPLE 5 | | | | | | |
| COMPARATIVE | — | — | — | — | — | — |
| EXAMPLE 6 | | | | | | |
| COMPARATIVE | — | 60 | — | 10 | — | — |
| EXAMPLE 7 | | | | | | |
| COMPARATIVE | — | — | — | — | 27 | — |
| EXAMPLE 8 | | | | | | |

WEIGHT PART RATIO
(SOLID CONTENT RATIO)
IPDI: ISOPHORONE DIISOCYANATE
H12MDI: DIOYOLOHEXYLMETHANE 4,4′-DIISOCYANATE
H6XDI: 1,3-BIS(ISOCYANATOMETHYL)CYCLOHEXANE
TMDI: TRIMETHYL-HEXAMETHYLENE DIISOCYANATE
TMXDI: TETRAMETHYL-XYLENE DIISOCYANATE
PPG: POLYPROPYLENE GLYCOL
PCDL: POLYCARBONATE DIOL
PTMG: POLYTETRAMETHYLENE GLYCOL
2HEA: 2-HYDROXYETHYL ACRYLATE
2HPA: 2-HYDROXYPROPYL ACRYLATE
4HBA: 4-HYDROXYBUTYL ACRYLATE

As main monomers, δ3.2 weight parts of the butyl acrylate (BA), 10 weight parts of the dimethyl acrylamide (DMAA), 16.8 weight parts of the 2-hydroxyethyl acrylate (2HEA) as a functional monomer, were solution-polymerized in a solvent of ethyl acetate. As a result, the acrylic copolymer (A1) was generated with a weight average molecular weight of 500,000 and glass transition temperature of −10 degrees Celsius. Then, 100 weight parts of the solid content of the acrylic copolymer, and 4.2 weight parts of methacryloyl oxyethyl isocyanate (MOI, 62 equivalents per 100 equivalents of the functional group of the acrylic copolymer) as an unsaturated compound (a monomer having an unsaturated group) were mixed together to create a reaction producing the energy-ray curable acrylic copolymer as a solution (30 percent solution) in the ethyl acetate.

To form the energy-ray curable urethane acrylate of the working example 1, 28 weight parts of an isophorone diisocyanate (IPDI) as a polyisocyanate, 60 weight parts of a polypropylene glycol (PPG) as a polyol were polymerized in the solvent of methylcarbitol methacrylate. Later, 12 weight parts of a 2-hydroxypropyl acrylate (2HPA) as an acrylate was further mixed, and dibutyl tin laurylate as a reaction promoter was added and mixed together to create a reaction producing the energy-ray curable urethane acrylate as a solution (70 percent solution) in the ethyl acetate.

To the 100 weight parts of the energy-ray curable acrylic copolymer, 0.37 weight parts (solid content ratio) of the polyisocyanate compound CL (“Colonate L”, trade name of a product of NIPPON POLYURETHANE INDUSTRY CO., LTD.) as a crosslinking agent, and 3.3 weight parts (solid content ratio) of a photopolymerization initiator PI (IRGACURE 184, trade name of a product of Ciba Specialty Chemicals K.K.) were mixed therein, and further, 20 weight parts (solid content ratio) of the energy-ray curable urethane acrylate was added thereto, thus obtaining the energy-ray curable adhesive of working example 1.

The energy-ray curable adhesive was applied with a roll knife coater, onto the surface of a release film, whose surface had been release-treated with a silicone resin. Then, the energy-ray curable adhesive and the release film were dried for one minute at 100 degrees Celsius to make the thickness of the energy-ray curable adhesive 40 μm. Later on, the energy-ray curable adhesive was laminated onto a substrate of polyethylene film with a thickness of 110 μm, thus resulting in the adhesive sheet of working example 1 that includes the energy-ray curable urethane acrylate whose formulation is represented in Table 1, in the energy-ray curable adhesive layer.

Note that in working examples 2 to 6 and comparative examples 1 to 4, 7, and 8, adhesive sheets were obtained by the same method as that of working example 1, other than the differences among formulations in the energy-ray curable urethane acrylates as represented in Table 1. In comparative examples 5 and 6, no energy-ray curable urethane acrylate is included. In comparative example 5, the energy-ray curable acrylic copolymer was formed by using an acrylic copolymer (A1) that includes 70 weight parts of the butyl acrylate (BA) and 30 weight parts of the 2-hydroxyethyl acrylate (2HEA). In comparative example 6, the energy-ray curable acrylic copolymer was formed by using an acrylic copolymer (A1) that includes 62 weight parts of butyl acrylate (BA), 10 weight parts of dimethyl acrylamide (DMAA), and 28 weight parts of 2-hydroxyethyl acrylate (2HEA).

Next, the evaluation test results for the energy-ray curable adhesive layers and the adhesive sheets of the working examples and comparative examples are explained. Table 2 represents the evaluation test results for the energy-ray curable adhesives and the adhesive sheets of working examples and comparative examples.

TABLE 2

| | | | VISCO- | | | | | |
|---|---|---|---|---|---|---|---|---|
| | | | ELAS- | | ADHESION | | | |
| | COMPATIBILITY | | TICITY | | STRENGTH | | | |
| | | | G′ | | NON-CURED | CURED | RESIDUAL | WATER |
| | VISUAL | HAZE | MPa | tan δ | mN/25 mm | mN/25 mm | ADHESIVE | PENETRATION |
| WORKING | ⊚ | 0.39 | 0.061 | 0.48 | 7000 | 200 | NO | NO |
| EXAMPLE 1 | | | | | | | | |
| WORKING | ⊚ | 0.52 | 0.074 | 0.46 | 7000 | 200 | NO | NO |
| EXAMPLE 2 | | | | | | | | |
| WORKING | ⊚ | 0.41 | 0.059 | 0.49 | 7300 | 230 | NO | NO |
| EXAMPLE 3 | | | | | | | | |
| WORKING | ⊚ | 0.71 | 0.031 | 0.48 | 4000 | 1500 | NO | NO |
| EXAMPLE 4 | | | | | | | | |
| WORKING | ⊚ | 0.79 | 0.038 | 0.56 | 7000 | 1500 | NO | NO |
| EXAMPLE 5 | | | | | | | | |
| WORKING | ◯ | 1.04 | 0.109 | 0.81 | 7400 | 110 | NO | NO |
| EXAMPLE 6 | | | | | | | | |
| COMPARATIVE | X | 2.33 | 0.060 | 0.55 | 7500 | 200 | YES | YES |
| EXAMPLE 1 | | | | | | | | |
| COMPARATIVE | X | 10.42 | 0.045 | 0.48 | 10100 | 110 | YES | YES |
| EXAMPLE 2 | | | | | | | | |
| COMPARATIVE | X | 2.00 | 0.110 | 0.65 | 7400 | 110 | YES | YES |
| EXAMPLE 3 | | | | | | | | |
| COMPARATIVE | X | 2.47 | 0.063 | 0.63 | 10500 | 120 | YES | YES |
| EXAMPLE 4 | | | | | | | | |
| COMPARATIVE | — | 1.40 | 0.114 | 0.45 | 5000 | 90 | NO | YES |
| EXAMPLE 5 | | | | | | | | |
| COMPARATIVE | — | 1.40 | 0.137 | 0.56 | 7100 | 80 | NO | YES |
| EXAMPLE 6 | | | | | | | | |
| COMPARATIVE | X | 10.77 | 0.033 | 0.56 | 10000 | 100 | YES | YES |
| EXAMPLE 7 | | | | | | | | |
| COMPARATIVE | X | 0.64 | 0.033 | 0.60 | 10750 | 40 | YES | YES |
| EXAMPLE 8 | | | | | | | | |

Haze: The adhesive sheets of the working and comparative examples used in the evaluation tests were formed by the same method as that explained above, except for the use of a polyester film with thickness of 100 μm instead of a substrate.
The release films were removed from the adhesive sheets, and the hazes of these sheets were measured at the adhesive surface of the energy-ray curable adhesive layers, based on JIS K7105.
Visual: The appearance of the energy-ray curable adhesive layers of the adhesive sheets was observed visually. ⊚: No indication of separation or turbidity (nebula) at all ◯: Slight indication of turbidity X: Strong indication of turbidity or separation
Storage modulus G′ and tan δ: Adhesive sheets of the working and comparative examples were obtained by the same production method as explained previously, with the difference being the use of two release films for protecting the exposed surfaces. These adhesive sheets include only the energy-ray curable adhesives, with the substrate having been omitted. These adhesive sheets were piled so that the energy-ray curable adhesive layer had a thickness of approximately 4 mm and dies having a cyrindrical-shape with an 8 mm diameter were cut from the piled adhesive sheets, in order to evaluate viscoelasticity.
The storage modulus G′ at 25 degrees Celsius and the values of tan δ of these test materials were measured by a viscoelasticity measuring device (DYNAMIC ANALYZER RDA II manufactured by REOMETRIC SCIENTIFIC F.E. LTD.).
The adhesion strength: The adhesion strength of the adhesive sheets of the working and comparative examples was measured by a versatile tensile tester (TENSILON/UTM-4-100 manufactured by ORIENTEC Co., Ltd.) by the same method as JIS Z0237, with the only difference being that the adherend surface was a mirror surface of a silicone wafer. The results of the tests are represented as adhesion strength in a non-cured state.
Further, the adhesive sheets, which had been laminated to mirror surfaces of a silicone wafers, were held for 20 minutes under conditions of 65 percent RH humidity at 23 degrees Celsius before the substrate side of the adhesive sheets was irradiated with an ultraviolet ray energy-ray (radiation condition: illuminance 350 mW/cm², amount of radiation 200 mJ/cm²), by an ultraviolet ray radiation device (RAD-2000 manufactured by LINTEC Corporation). The adhesion strength of the adhesive sheets to which the ultraviolet rays had been irradiated, was measured by the same method as that explained above, as the adhesion strength in a cured state.
Residual adhesive: The adhesive sheets were laminated on the mirror surfaces of silicon wafers (diameter: 8 inch, thickness: 720 μm). After the adhesive sheets were removed from the silicon wafers, the surfaces of the silicon wafers were analyzed by an XPS. Further, organic matter on the surfaces of the silicon wafers was observed by analyzing C and Si peaks, to detect the presence of residual adhesive.
Water penetration: Dummy wafers (diameter: 8 inch, thickness: 720 μm) with circuit patterns having the maximum height difference of 20 μm were prepared. These dummy wafers were half-cut diced on the circuit surface, in a 5 mm × 5 mm pitch grid, kerf width of 40 μm, and kerf depth of 130 μm, by a dicing device (DFD6361 manufactured by DISCO CORPORATION). The adhesive sheets of the working and comparative examples were laminated to the circuit surfaces of the half-diced dummy wafers by a tape laminator (RAD-3500 F/12 manufactured by LINTEC Corporation). Later, the backside surface of the dummy wafers was ground down to the thickness of 100 μm by a wafer backside surface grinding device (DGP8760 manufactured by DISCO CORPORATION). Then, an ultraviolet ray as an energy-ray was irradiated to the chips (radiation condition: illuminance 350 mW/cm², amount of radiation 200 mJ/cm²) by the ultraviolet ray radiation device (RAD-2000 manufactured by LINTEC Corporation), and the adhesive was removed from the dummy wafers by a tape mounter with a tape removing device (RAD-2700 F/12 manufactured by LINTEC Corporation). The exposed circuit patterns were then observed through a microscope (digital microscope VHX-200 manufactured by KEYENCE CORPORATION) at 2000 magnification. Based on observation results, an evaluation was made as to whether or not water penetration resulted in contamination of the wafer surface, and whether or not the residual adhesive was detected.

As is clear from Table 2, the energy-ray curable adhesives of working examples 1 to 6 have sufficient compatibility between the energy-ray curable urethane acrylate and the energy-ray curable acrylic copolymer. This is expected because the energy-ray curable adhesives of working examples 1 to 6 show better evaluation results in visual compatibility and have smaller haze values, than those of comparative examples 1 to 8. As indicated in Table 1, the energy-ray curable urethane acrylate of working examples 1 to 6 includes at least one of an isophorone diisocyanate (IPDI), a trimethyl-hexamethyene diisocyanate (TMDI), and a tetramethyl-xylene diisocyanate (TMXDI) as the isocyanate blocks, unlike comparative examples 1 to 8.

Therefore, it is evident that the compatibility of the energy-ray curable urethane acrylate with the energy-ray curable acrylic copolymer is improved by using one of the IPDI, TMDI, and TMXDI, in this embodiment.

Because in working examples 1 to 6 and comparative examples 1 to 8, the storage moduli G′ at 25 degrees Celsius are lower than or equal to 0.15 MPa, and the values of tan δ are greater than or equal to 0.4 (see Table 2), these energy-ray curable adhesives have sufficient viscoelasticity, and excellent adhesion strength in the non-cured state. By comparing examples which have almost the same adhesion strength in both the cured and non-cured states among the working examples 1 to 6 and comparative examples 1 to 8 (for example, working examples 1, 2, and comparative example 1, or working example 6 and comparative example 3), it is clear that all of these working examples have superior performance with respect to residual adhesive and water penetration, than the corresponding comparative examples.

As explained above, the energy-ray curable adhesives of the working examples can prevent deposits of residual adhesive matter and the penetration of water, more reliably than the comparative examples, by improving the compatibility of the energy-ray curable urethane acrylate to the energy-ray curable acrylic copolymer, by using the IPDI, TMDI, and TMXDI. Therefore, it is preferable to form the energy-ray curable urethane acrylate by an isocyanate including at least one of the IPDI, TMDI, and TMXDI. Further, a mixture isocyanate block that has more than two of the IPDI, TMDI, and TMXDI, may be used for forming the energy-ray curable urethane acrylate.

Note that in working examples 1 to 5, the compatibility between the energy-ray curable urethane acrylate and the energy-ray curable acrylic copolymer is more than adequate, and all of these energy-ray curable urethane acrylates of the working examples include a polypropylene glycol (PPG) as a polyol to form a polyol block (see Table 1). Therefore, by using PPG as one of materials for forming the energy-ray curable urethane acrylate, its compatibility can be further improved. However, polyols such as the PPG may not be used, because the energy-ray curable urethane acrylate can be generated only from an isocyanate and an acrylate.

As the results in Table 2 show, the energy-ray curable urethane acrylate is preferably an oligomer with a number average molecular weight of approximately equal to or below 20,000.

As explained above, in this embodiment, an adhesive sheet that has sufficient adhesion strength, followability to bond to the uneven circuit surface of a wafer and so on, that can prevent the penetration of water for grinding onto the circuit surface of a wafer during grinding processes, and that can prevent residual adhesive matter, is realized.

The materials of the members constituting the adhesive sheet are not limited to those exemplified in the embodiment. Further, the adhesive sheet can be used for various purposes, that is, the adhesive sheet can be used not only for protecting a semiconductor wafer under the grinding step of the DBG process, but also for protecting a semiconductor wafer under a conventional process and for protecting the surface of parts other than semiconductor wafers.

This invention is not limited to that described in the preferred embodiment, namely, various improvements and changes may be made to the present invention without departing from the spirit and scope thereof.

The present disclosure relates to subject matter contained in Japanese Patent Application No. 2007-072510 (filed on Mar. 20, 2007) which is expressly incorporated herein, by reference, in its entirety.

1. An adhesive sheet comprises:
a substrate; and
an energy-ray curable adhesive layer formed on said substrate,
said energy-ray curable adhesive layer comprising an energy-ray curable acrylic copolymer and an energy-ray curable urethane acrylate; said energy-ray curable acrylic copolymer being formed by copolymerizing dialkyl(meth)acrylamide and comprising a side chain with an unsaturated group, said energy-ray curable urethane acrylate comprising an isocyanate block and a (meth)acryloyl group, said isocyanate block comprising at least one of an isophorone diisocyanate, a trimethyl-hexamethyene diisocyanate, and a tetramethyl-xylene diisocyanate.

2. The adhesive sheet according to claim 1, wherein said energy-ray curable urethane acrylate further comprises a polyol block.

3. The adhesive sheet according to claim 2, wherein a polyol to form said polyol block comprises a polypropylene glycol.

4. The adhesive sheet according to claim 1, wherein the number average molecular weight of said energy-ray curable urethane acrylate is less than or equal to 20,000.

5. The adhesive sheet according to claim 1, wherein said energy-ray curable adhesive layer is formed by mixing 100 weight parts of said energy-ray curable acrylic copolymer and 1 to 200 weight parts of said energy-ray curable urethane acrylate, said energy-ray curable acrylic copolymer being formed by a reaction of an acrylic copolymer and an unsaturated compound, said acrylic copolymer comprising said dialkyl(meth)acrylamide and 100 equivalents of a functional group, said unsaturated compound comprising 20 to 100 equivalents of a substitution group that is reactable with said functional group.

6. The adhesive sheet according to claim 1, wherein the storage modulus of said energy-ray curable adhesive layer is lower than or equal to 0.15 MPa at 25 degrees Celsius, and the value of tan δ of said energy-ray curable adhesive layer at 25 degrees Celsius is greater than or equal to 0.4, when said energy-ray curable adhesive layer is not cured by energy-rays.
